(19) United States
(12) Patent Application Publication
(10) Pub. No.: US 2007/0205322 A1
(43) Pub. Date: Sep. 6, 2007

(54) Micro aviation vehicle

(76) Inventor: Wei-Hsiang Liao, Hsin-Chu City (TW)

Correspondence Address: RABIN & Berdo, PC, 1101 14TH STREET, NW, SUITE 500, WASHINGTON, DC, 20005, US

(21) Appl. No.: 11/367,377

(22) Filed: Mar. 6, 2006

(51) Int. Cl. B64C 33/00

(52) U.S. Cl. 244/22

(57) ABSTRACT

A micro aviation vehicle is provided which includes a body, a first wing set, a second wing set, an actuator and a power module. The first wing set and the second wing set are disposed on the left and right sides of the body respectively, and are connected with one end of the actuator. A first angle controller and a second angle controller are used to control the swing angle of the first wing set and the swing angle of the second wing set, respectively. The power module draws the actuator through the rotation of a driving gear, and then the first wing set together with the second wing set are associated with the actuator to flap back-and-forth.

### BACKGROUND OF THE INVENTION

1. Field of Invention

The present invention relates to an aviation vehicle, and particularly to a micro aviation vehicle which is miniaturized and simple structured.

2. Related Art

The study of the flight of insects is a profound academic field.

For example, the flight activities of a fruit fly include the steps of rapid taking off, hovering, diving, and making an abrupt turn and the like. These excellent flight skills let fruit flies easily hunt for food and escape man's pursuit.

The functions of the light and thin wings of insects are obviously different from those of the big wings of birds. Specialists in zoology, aeronautics, astronautics, and fluid dynamics have always had a great interest in the flight activities of creatures in nature, and especially in the flight activities of insects. But this action has not yet been fully understood.

The difficulty is that people have encounter difficulty attempting to describe precisely flow field in three-dimensional space, and particularly the air flow field around the wings of insects. The wings of insects are quite small and move quite rapidly, and are quite complex.

Scientists in the early days investigated the mechanism of insect flight by steady-state aerodynamics analysis and Navier-Stokes equation. However, these methods still fail to explain the insect activities of taking off and hovering in the air, they also failed to depict the insect flight. In the 1980s, researchers have employed direct measurement methods to numerical scheme the activities of insect movement, and the secrets of insect flight activity has gradually been uncovered.

Nowadays, the principles of insect flight have been discussed and studied in many articles, and a preliminary understanding has been achieved. In general, a certain lift force may be produced due to the difference in swing direction and angle of the wings. The air flow phenomena, such as the leading-edge vortex, the delayed stall, the rotation lift and the wake capture, discovered from insect flight activities by scientists, are nowadays being partly applied.

Although many principles have been worked out by scientists, it does not mean that the micro aviation vehicle can be produced accordingly. There are still many technical problems to be solved in practical application. Such an aviation vehicle is disclosed in the U.S. Patent No. 20040155145, based on the known aerodynamic theory. 20040155145 mainly discloses that one end of the wing is connected to a cam having a first stopper and a second stopper, and a driving plate is rotated after being drawn by a driver, and thus the cam and the wings are drawn accordingly to move, and finally the aviation vehicle flies. Furthermore, the aviation vehicle disclosed in the U.S. Pat. No. 6,540,177 simulates the flight of the dragonfly mainly through the use of several linkages. The U.S. Pat. No. 6,530,540 discloses a manned aviation vehicle.

Although these patents or conventional aviation vehicles are operable and achieve certain results, these aviation vehicles are difficult to be realized, or too complex in structure, expensive and difficult to miniaturize, and thus are still wanting in these respects.

### SUMMARY OF THE INVENTION

In view of this, the present invention discloses a micro aviation vehicle with the advantage of being miniaturized easily owing to the simple structure thereof.

The micro aviation vehicle provided by the present invention includes a body, first and second wing sets, first and second angle controllers, an actuator, and a power module. The body is disposed with a right shaft and a left shaft corresponding to each other. The first wing set having a first arm and a first wing is disposed on the right side of the body, wherein a first slot is formed at a proper position in the middle of the first arm for the right shaft to pass through. The first angle controller is disposed on the first arm for controlling the relative swing angle of the first wing to the first arm. As for the construction of the second wing set, it is almost the same as that of the first wing set, and the configuration and function of the second angle controller are also the same as that of the first angle controller.

One end of the actuator is connected with the first arm and the second arm. The power module includes a driving gear and a driving motor associated with the driving gear to drive the driving gear to rotate. The other end of the actuator is associated with the driving gear, and when the driving gear rotates, the first arm together with the second arm are associated by the actuator, so that the first wing and the second wing flap back-and-forth with the right shaft and the left shaft as axes respectively. In order to the make the aforementioned and other objects, features and advantages of the present invention more comprehensible, preferred embodiments accompanied with appended drawings are described in detail below.

### BRIEF DESCRIPTION OF THE DRAWINGS

FIG. 1 is an exploded schematic view of a micro aviation vehicle according to the present invention;

FIG. 2 is a combined schematic view of a micro aviation vehicle according to the present invention;

FIG. 3 is a schematic view of an angle controller of a micro aviation vehicle according to the present invention;

FIG. 4 is a schematic view of the first action of the micro aviation vehicle according to the present invention; and

FIG. 5 is a schematic view of the second action of the micro aviation vehicle according to the present invention.

### DETAILED DESCRIPTION OF TIHE INVENTION

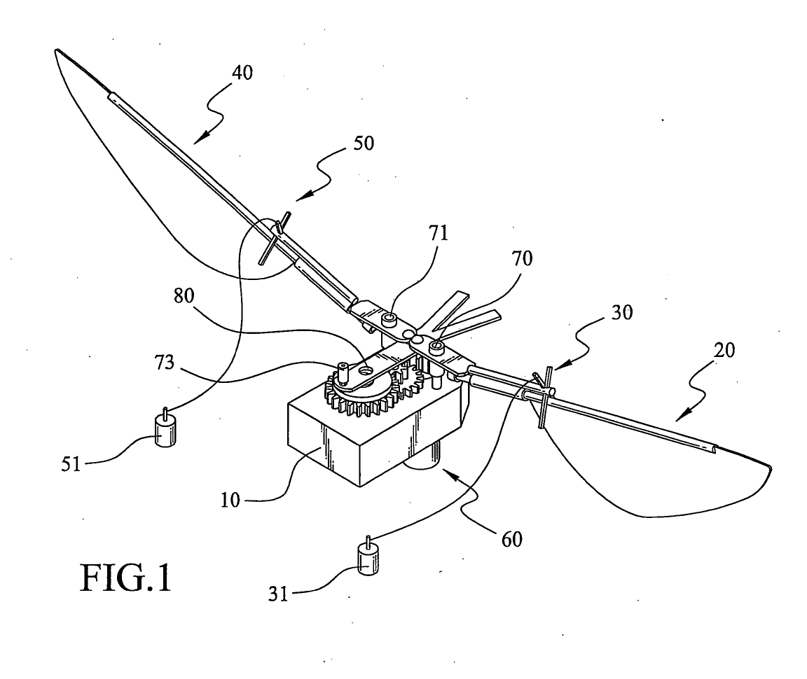

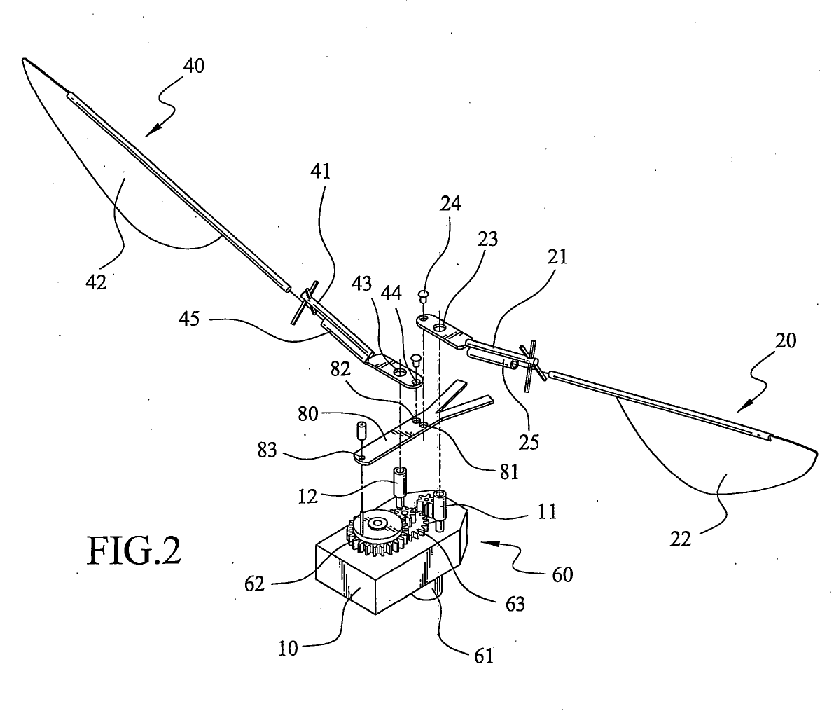

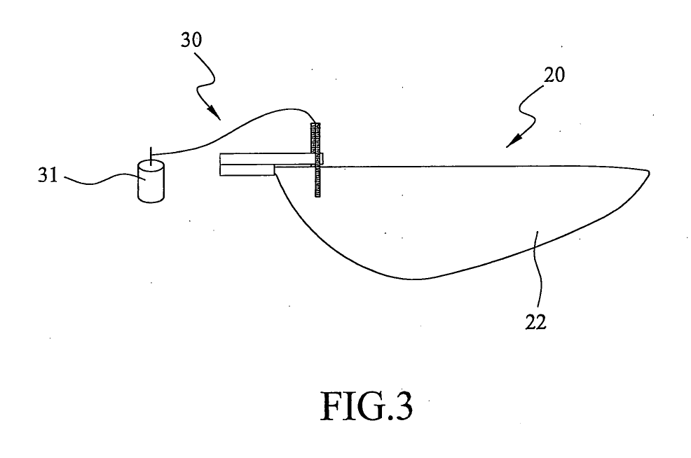

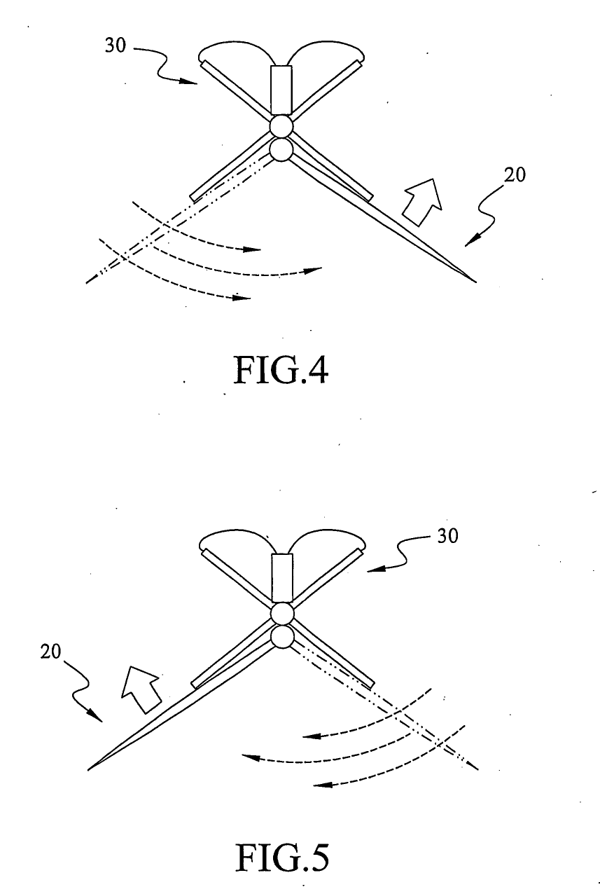

The constitution of the main elements, structural features, and action methods according to the micro aviation vehicle of an embodiment of the present invention are illustrated in FIGS. 1, 2, 3, 4, and 5.

The embodiment of the present invention includes a body 10, a first wing set 20, a first angle controller 30, a second wing set 40, a second angle controller 50, an actuator 80, and a power module 60. A right shaft 11 and a left shaft 12 are respectively disposed on the body 10, and the first wing set 20 is disposed on the right side of the body 10 and mainly includes a first arm 21 and a first wing 22. A first slot 23 and a first lock-hole 24 are formed at a proper position in the middle of the first arm 21. A sleeve 25 is disposed on the bottom of the first arm 21. The first slot 23 is for the right shaft to pass through and to slide in. The first wing 22 is accommodated into the sleeve 25 and can rotate and swing freely relative to the first arm 21.

The second wing set 40 is disposed on the left side of the body 10, symmetrically to the first wing set 20, and the component parts and parts action relationships of the second wing set 40 are the same as those of the first wing set 20. The second wing set 40 mainly includes a second arm 41 and a second wing 42. A second slot 43 and a second lock-hole 44 are formed at a proper position in the middle of the second arm 41, A sleeve 45 is disposed on the bottom. The second slot 43 is for the left shaft 12 to pass through and to slides in. The second wing 42 is accommodated into the sleeve 45 and can rotate and swing freely relative to the second arm 41.

A power module 60 having a driving gear 62 disposed on the body 10 and a driving motor 61 disposed on the bottom of the body 10. A power gear 63 is disposed between the driving gear 62 and the driving motor 61 and is engaged with both the driving gear 62 and the driving motor 61. Thus, the driving motor 61 can be associated with the gear the driving gear 62 and drive the driving gear 62 to rotate.

The front end of the actuator 80 is provided with a first circular hole 81 and a second circular hole 82, and the rear end is provided with a reamed hole 83. The fastener 70 passes through the first lock-hole 24 of the first wing set 20 and is then locked at the first circular hole 81, so that the first wing set 20 is connected to the actuator 80. Similarly, the fastener 71 passes through the second lock-hole 44 of the second wing set 40 and is then locked at the second circular hole 82 of the actuator 80, so that the second wing set 20 is connected to the actuator 80. The fastener 73 passes through the reamed hole 83 in order to connect the rear end of the actuator 80 to the shaft on the driving gear 62.

As a result, when the driving motor 61 is activated, the driving gear 62 will be driven to rotate, and the actuator 80 will be drawn to move back-and-forth linearly, and thus the first wing set 20 and the second wing set 40 are drawn to flap back-and-forth, relative to the body 10, with the right shaft 11 and the left shaft 12 as axes respectively, thereby resulting in a flying action like that of insects flapping their thin wings.

Two angle controllers 30, 50 according to the embodiment of the present invention will be described below.

The first angle controller 30 and the second angle controller 50 in the present invention are disposed on the first arm 21 of the first wing set 20 and the second arm 41 of the second wing set 40, respectively. Since the functions of the two angle controllers 30, 50 are the same, the first angle controller 30 will be taken as an illustration below. The first angle controller 30 has two moveable plates 32, wherein the relative unfolding angle between the two movable plates 32 are controlled by the first servo motor 31, and thereby the range of the swing angle of the first wing 22 can be restricted. When the first wing set 20 and the second wing set 40 change flapping directions, the resulting following air flow and inertia enable the first wing 22 and the second wing 42 to start to swing. However, the swing will stop due to the limitation on the unfolding angle between the first and second angle controllers 30 and 50, thus the maximal lift force may be obtained by changing the angle between the two wings 22, 42.

What is claimed is:

1. A micro aviation vehicle, comprising:
a body, provided with a right shaft and a left shaft corresponding to each other;
a first wing set disposed on the right side of the body, the first wing set including a first arm, a first wing connected in a manner allowing for rotation and swinging to the first arm, a first slot being formed at a proper position in the middle of the first arm for the right shaft to pass through;
a first angle controller disposed on the first arm for controlling the relative swing angle of the first wing to the first arm;
a second wing set, disposed on the left side of the body, the second wing set including a second arm, a second wing connected in a manner allowing for rotation and swinging to the second arm, a second slot being formed at a proper position in the middle of the second arm for the left shaft to pass through;
a second angle controller disposed on the second arm for controlling the swing angle of the second wing relative to the second arm;
an actuator with one end connected to one end of the first arm and one end of the second arm; and
a power module including a driving gear and a driving motor associated with the driving gear to enable the driving gear to rotate, wherein the other end of the actuator is associated with the driving gear, and when the driving gear rotates, the first arm together with the second arm are associated by the actuator, so that the first wing and the second wing flap to-and-fro with the right shaft and the left shaft as axes respectively.

2. The micro aviation vehicle as claimed in claim 1, wherein the driving motor drives the driving gear through a power gear.

3. The micro aviation vehicle as claimed in claim 1, wherein the first angle controller controls the unfolding angle thereof through a first servo motor.

4. The micro aviation vehicle as claimed in claim 1, wherein the second angle controller controls the unfolding angle thereof through a second servo motor.

5. The micro aviation vehicle as claimed in claim 1, wherein the first arm is associated with a sleeve so as to accommodate the first wing.

6. The micro aviation vehicle as claimed in claim 1, wherein the second arm is associated with a sleeve so as to accommodate the second wing.
